(19) United States
(12) Patent Application Publication
(10) Pub. No.: US 2026/0178824 A1
(43) Pub. Date: Jun. 25, 2026

(54) MANAGING MEMORY UTILIZATION FOR SPREADSHEET FUNCTIONALITY

(71) Applicant: Georgetown Software House, Inc., Washington, DC (US)

(72) Inventors: Bediako Ntodi George, Washington, DC (US); Mark Enebo Mendell, Long Island City, NY (US)

(21) Appl. No.: 19/544,947

(22) Filed: Feb. 19, 2026

Related U.S. Application Data
(63) Continuation of application No. PCT/US2025/044684, filed on Sep. 3, 2025.
(60) Provisional application No. 63/697,864, filed on Sep. 23, 2024.

(51) Int. Cl. G06F 40/18; G06F 40/106

(52) U.S. Cl. CPC G06F 40/18; G06F 40/106

(57) ABSTRACT

The present teachings generally include techniques and systems for managing memory utilization in processing spreadsheet functionality, including handling data of certain cells virtually by referencing related data and efficiently handling duplicate data. The present teachings may include methods for determining mapping functions that reference target cells to input cells, call the mapping functions when data from a target cell is requested, and access input data according to the mapping functions to determine the data of the requested target cells. In addition, or instead, the techniques may involve identifying duplicate data between collections of cells, storing the duplicate data independently, and referencing the original cell collections to the independently stored duplicate data. These techniques can be useful for, inter alia, reducing memory usage, improving computational performance, and enabling more efficient manipulation of large spreadsheets with redundant data across multiple worksheets or sections.

### CROSS-REFERENCE TO RELATED APPLICATIONS

This application is a bypass continuation that claims priority to International Patent Application No. PCT/US2025/044684 filed on Sep. 3, 2025, which claims priority to U.S. Provisional Pat. App. No. 63/697,864 filed on Sep. 23, 2024, the entire contents of which is hereby incorporated by reference herein.

### FIELD

The present disclosure generally relates to systems and techniques for managing memory utilization in processing spreadsheets, e.g., including techniques for determining and using mapping functions related to processing operations and/or reducing duplication of data.

### BACKGROUND

Spreadsheets are widely used across various industries for computational tasks such as data analysis, financial modeling, supply chain management, and others. Such demanding applications often involve handling large datasets, complex formulas, multiple interconnected worksheets, and frequent updates, which can strain the functionality and performance of traditional spreadsheet systems. As spreadsheets grow in complexity and size, they often demand significant computational resources and memory to process and display large amounts of data and handle the related calculations. One of the challenges in managing large and complex spreadsheets, therefore, is the efficient utilization of computer memory, which becomes critical in scenarios involving frequent updates or large-scale operations.

A spreadsheet is a document including a collection of cells containing data items such as numbers, strings, dates, and so on. Cells may also or instead include instructions e.g., computational instructions such as formulas and functions, and/or snippets of code, pointers and references to other cells, and the like. Cells may also or instead contain other types of information such as data formatting information, presentation information, form widgets, descriptive notes or comments, and so on. Cells in a spreadsheet may be arranged in a geometric fashion, typically in rows and columns having unique names. These rows and columns can also be grouped, where these groups are typically referred to as worksheets. A cell's location in a spreadsheet is usually specified using a combination of the worksheet name and the row/column in which the cell resides.

There remains a need for improved memory management techniques in spreadsheet processing, e.g., to efficiently and effectively handle large datasets and complex operations while reducing computational resource usage.

### SUMMARY

The present teachings generally include techniques and systems for managing memory utilization in processing spreadsheet functionality, including handling data of certain cells virtually by referencing related data and efficiently handling duplicate data. The present teachings may include methods for determining mapping functions that reference target cells to input cells, call the mapping functions when data from a target cell is requested, and access input data according to the mapping functions to determine the data of the requested target cells. In addition, or instead, the techniques may involve identifying duplicate data between collections of cells, storing the duplicate data independently, and referencing the original cell collections to the independently stored duplicate data. These techniques can be useful for, inter alia, reducing memory usage, improving computational performance, and enabling more efficient manipulation of large spreadsheets with redundant data across multiple worksheets or sections.

In an example aspect, a computer program product disclosed herein may include computer executable code embodied in a non-transitory computer readable medium that, when executing on one or more computing devices, performs the steps of: receiving (i) a collection of input cells including input data, each of the input cells having a cell address, and (ii) one or more operations programmatically configured to manipulate the input data to generate output data; determining, based on the one or more operations, a mapping function programmatically configured to reference a collection of target cells to the collection of input cells, the collection of target cells representing one of the output data and intermediary data used to generate the output data; receiving a request for a first value of a target cell of the collection of target cells; after receiving the request, calling the mapping function to determine the cell address of a first input cell to which the target cell refers; accessing the input data of the first input cell using the cell address; and determining the first value of the target cell based at least on the input data of the first input cell. Other implementations of this aspect include corresponding computer systems, apparatus, methods, and computer programs recorded on one or more computer storage devices, each configured to perform one or more of the aforementioned steps.

Implementations of this example aspect, or any other example aspect described in this summary section or otherwise herein, may include one or more of the following features. The one or more operations may include at least one of a function and a directive associated with the collection of input cells. The one or more operations may specify at least one of generation, manipulation, and arrangement of at least one of the input cells and the target cells. The one or more operations may include a directive, the directive including information related to at least one of duplicating a cell, filtering a cell, sorting a cell, and reordering a cell. The one or more operations may include one or more of a mathematical function and a computing function. Each of the one or more operations may relate to a distinct mapping function. The collection of input cells may contain the one or more operations. The mapping function may include: (i) a first mapping function that references a first collection of target cells representing intermediary data to the collection of input cells, and (ii) a second mapping function that references a second collection of target cells representing output data to the first collection of target cells. The computer program product may include code that, when executed on one or more computing devices, performs the steps of: calling the first mapping function independently of the second mapping function, and determining a value of one or more cells of the first collection of target cells. The computer program product may include code that, when executed on one or more computing devices, performs the step of determining a value of one or more cells of the second collection of target cells without determining a value of the first collection of target cells. The mapping function may include an inverse of the one or more operations. The mapping function may describe a one to one relationship between the collection of input cells and the collection of target cells. The computer program product may include code that, when executed on one or more computing devices, performs the step of storing the mapping function to a database. The computer program product may include code that, when executed on one or more computing devices, performs the step of, after determining the first value of the target cell, displaying the target cell via a user interface. Before receiving the request for the first value of the target cell, the target cell may be displayed as one or more of the following: blank, empty, zero value, hidden, or marked as inactive. Before receiving the request for the first value of the target cell, the target cell may be virtual. Implementations of the described techniques may include hardware, a method or process, and/or computer software on a computer-accessible medium.

In an example aspect, a method for managing memory utilization in processing spreadsheet functionality disclosed herein may include: receiving (i) a collection of input cells including input data, each of the input cells having a cell address, and (ii) one or more operations programmatically configured to manipulate the input data to generate output data; determining, based on the one or more operations, a mapping function programmatically configured to reference a collection of target cells to the collection of input cells, the collection of target cells representing one of the output data and intermediary data used to generate the output data; receiving a request for a first value of a target cell of the collection of target cells; after receiving the request, calling the mapping function to determine the cell address of a first input cell to which the target cell refers; accessing the input data of the first input cell using the cell address; and determining the first value of the target cell based at least on the input data of the first input cell. Other implementations of this aspect include corresponding computer systems, apparatus, methods, and computer programs recorded on one or more computer storage devices, each configured to perform one or more of the aforementioned steps.

In an example aspect, a system disclosed herein for managing memory utilization in processing spreadsheet functionality may include: a data network; and a remote computing resource coupled to the data network, the remote computing resource including a processor and a memory, the memory storing code executable by the processor to perform the steps of: receiving (i) a collection of input cells including input data, each of the input cells having a cell address, and (ii) one or more operations programmatically configured to manipulate the input data to generate output data; determining, based on the one or more operations, a mapping function programmatically configured to reference a collection of target cells to the collection of input cells, the collection of target cells representing one of the output data and intermediary data used to generate the output data; receiving a request for a first value of a target cell of the collection of target cells; after receiving the request, calling the mapping function to determine the cell address of a first input cell to which the target cell refers; accessing the input data of the first input cell using the cell address; and determining the first value of the target cell based at least on the input data of the first input cell. Other implementations of this aspect include corresponding computer systems, apparatus, methods, and computer programs recorded on one or more computer storage devices, each configured to perform one or more of the aforementioned functions.

In an example aspect, a computer program product disclosed herein for managing memory utilization in processing spreadsheet functionality may include computer executable code embodied in a non-transitory computer readable medium that, when executing on one or more computing devices, performs the steps of: receiving a first collection of cells and one or more operations programmatically configured to manipulate the first collection of cells to generate a second collection of cells; identifying, based on the one or more operations, the presence of duplicate data in common between the first collection of cells and the second collection of cells; storing the duplicate data independently of the first collection of cells and the second collection of cells; referencing each of the first collection of cells and the second collection of cells to the duplicate data; receiving a request for a value of a target cell within one of the first collection of cells and the second collection of cells; and after receiving the request, determining the first value of the target cell based on the reference to the duplicate data. Other implementations of this aspect include corresponding computer systems, apparatus, methods, and computer programs recorded on one or more computer storage devices, each configured to perform one or more of the aforementioned steps.

Implementations of this example aspect, or any other example aspect described in this summary section or otherwise herein, may include one or more of the following features. The computer program product may include code that, when executed on one or more computing devices, performs the step of removing the duplicate data from the first collection of cells. The computer program product may include code that, when executed on one or more computing devices, performs the step of, after determining the first value of the target cell, displaying the target cell via a user interface. Implementations of the described techniques may include hardware, a method or process, and/or computer software on a computer-accessible medium.

In an example aspect, a method for managing memory utilization in processing spreadsheet functionality disclosed herein may include: receiving a first collection of cells and one or more operations programmatically configured to manipulate the first collection of cells to generate a second collection of cells; identifying, based on the one or more operations, the presence of duplicate data in common between the first collection of cells and the second collection of cells; storing the duplicate data independently of the first collection of cells and the second collection of cells; referencing each of the first collection of cells and the second collection of cells to the duplicate data; receiving a request for a value of a target cell within one of the first collection of cells and the second collection of cells; and after receiving the request, determining the first value of the target cell based on the reference to the duplicate data. Other implementations of this aspect include corresponding computer systems, apparatus, methods, and computer programs recorded on one or more computer storage devices, each configured to perform one or more of the aforementioned steps.

In an example aspect, a system disclosed herein for managing memory utilization in processing spreadsheet functionality may include: a data network; and a remote computing resource coupled to the data network, the remote computing resource including a processor and a memory, the memory storing code executable by the processor to perform the steps of: receiving a first collection of cells and one or more operations programmatically configured to manipulate the first collection of cells to generate a second collection of cells; identifying, based on the one or more operations, the presence of duplicate data in common between the first collection of cells and the second collection of cells; storing the duplicate data independently of the first collection of cells and the second collection of cells; referencing each of the first collection of cells and the second collection of cells to the duplicate data; receiving a request for a value of a target cell within one of the first collection of cells and the second collection of cells; and after receiving the request, determining the first value of the target cell based on the reference to the duplicate data. Other implementations of this aspect include corresponding computer systems, apparatus, methods, and computer programs recorded on one or more computer storage devices, each configured to perform one or more of the aforementioned functions.

These and other features, aspects, and advantages of the present teachings will become better understood with reference to the following description, examples, and appended claims.

### BRIEF DESCRIPTION OF THE DRAWINGS

The foregoing and other objects, features, and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 illustrates a system for managing memory utilization for spreadsheets, in accordance with a representative example.

FIG. 2 illustrates a spreadsheet process, in accordance with a representative example.

FIG. 3 illustrates a spreadsheet process, in accordance with a representative example.

FIG. 4 is a flow chart of a method for managing memory utilization for spreadsheets, in accordance with a representative example.

FIG. 5 is a flow chart of a method for managing memory utilization for spreadsheets, in accordance with a representative example.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, and methods disclosed herein relate to systems and techniques for managing memory utilization in processing spreadsheet functionality. That is, an aspect of the present teachings includes a data processing platform with components (e.g., hardware and/or software components) configured for efficiently handling large spreadsheet datasets by reducing memory usage while still enabling access to cell values, inputs, and/or outputs as needed. In an aspect, techniques described herein may utilize mapping functions to reference target cells to input cells, rather than fully rendering data of the target cells. The present teachings may also or instead include techniques for identifying and managing duplicate data across multiple cell collections in a spreadsheet, allowing that data to be stored once and referenced by multiple collections. These approaches enable spreadsheet functionality to be provided for large datasets with improved memory efficiency compared to fully materializing the data output of all spreadsheet operations.

The present teachings may, in some aspects, more specifically include receiving input cells with data and operations for manipulating that data, determining mapping functions to reference target cells (representing output data or intermediary data) to the input cells, and using those mapping functions to determine target cell values only when requested or otherwise appropriate. This may allow spreadsheets with many operations to be processed without necessarily materializing all intermediate steps and/or outputs in memory. The mapping functions may utilize mathematical and/or computing operations to efficiently determine how target cells relate back to input data.

As used herein, it will be understood that the term “input cells” may generally refer to cells in a spreadsheet containing data values that serve as the basis for calculations, transformations, or other operations. Input cells may contain, e.g., numbers, strings, dates, and other data types that may be provided, e.g., by a user, may be passed from another spreadsheet or other data source, or may be the output of an operation performed in the same, or another, spreadsheet. In this sense, an input cell of a first operation may be considered an output cell with respect to another (e.g., previously executed) operation.

As used herein, it will be understood that the term “target cells” may generally refer to cells in a spreadsheet including, or destined to include, data that is the result of operations performed on input cells. A target cell may represent either the result of an intermediate operation (e.g., a non-final step in a sequence of operations) or final output data (e.g., the output of a sequence of operations, or of an operation including multiple steps). In some aspects, a target cell may be an intermediate cell that itself is an input for output data; in such aspects, the output data may or may not be needed, but rather the intermediate cell may be desired, thus rendering it a target cell in an operation according to the present teachings. Target cells may be virtual, existing as references or potential calculations until explicitly requested or rendered.

As used herein, it will be understood that the term “operation” may generally refer to a function, formula, directive, and/or other instruction that specifies how data of an input cell should be manipulated or transformed to produce a target cell value. For example, an operation may include at least one of a function and a directive associated with a collection of input cells. A function may include, e.g., a mathematical function and/or a computing function, such as a cell manipulation (e.g., a sort or join function), a conditional function (e.g., if, and, or), or a conversion function (e.g., between different units or formats or the like.) A directive may include instructions for processing data of an input cell and/or generating a target cell value, for example as described in detail in applicant's own U.S. Pat. No. 11,238,214, the entire content of which is hereby incorporated by reference herein. For example, a directive may include information related to at least one of duplicating a cell, filtering a cell, sorting a cell, and reordering a cell. In some aspects, an operation may specify at least one of generation, manipulation, and arrangement of cells (e.g., of at least one of the input cells and the target cells).

As used herein, it will be understood that the term “mapping function” may generally refer to a programmatic relationship that defines how target cells relate back to input cells (and/or intermediate cells), allowing for the determination of target cell values without necessarily materializing all intermediate data.

As used herein, it will be understood that the term “virtual” may generally refer to the state of a cell or data that is defined but not yet materialized or computed, existing, e.g., as a reference, potential calculation, or similar until explicitly requested or rendered.

As used herein, it will be understood that the term “cell generation” may generally refer to the creation of a new cell that is added to a worksheet within a spreadsheet. Cell generation can also or instead refer to other methods of creating cells such as copying existing cells and/or moving a cell from one location to another. Cells may be generated singly or in groups.

As used herein, it will be understood that the term “cell manipulation” may generally refer to the replacement of an existing cell with a new cell, and/or updating the contents of an existing cell with new data, computational instructions, or the like. Cell manipulation may also or instead include removing a cell from a spreadsheet. Cells may be manipulated singly or in groups.

As used herein, it will be understood that the term “cell arrangement” may generally refer to the spatial association of cells in columns or rows. This may include specifying or changing the ordering, grouping, and/or dependencies of cells. Cells may be arranged singly or in groups.

As used herein, it will be understood that the term “render” may generally refer to the process of materializing or computing the actual values of cells, typically for display or output purposes.

This disclosure may include using a submission module that may be part of an online platform that performs techniques of the present teachings, which the submission module may include a spreadsheet and input data, along with the associated operations that may be submitted to a parser module (e.g., an analysis engine operating on a remote computing resource, which again may be part of a web-based platform that implements techniques of the present teachings). The parser module may in some cases extract operations from the spreadsheet. The operations, along with the input, may then be evaluated by an execution module (which again may be part of a web-based platform that implements techniques of the present teachings, e.g., part of the analysis engine operating on a remote computing resource). The execution module may determine mapping functions and/or the presence of duplicate data, and may process operations or mapping functions in the manner indicated by the associated spreadsheet. The results may be stored (e.g., on a storage module of the web-based platform) and made available to a user via a viewing module (e.g., an interface of the web-based platform), and/or the results may be transmitted to a user.

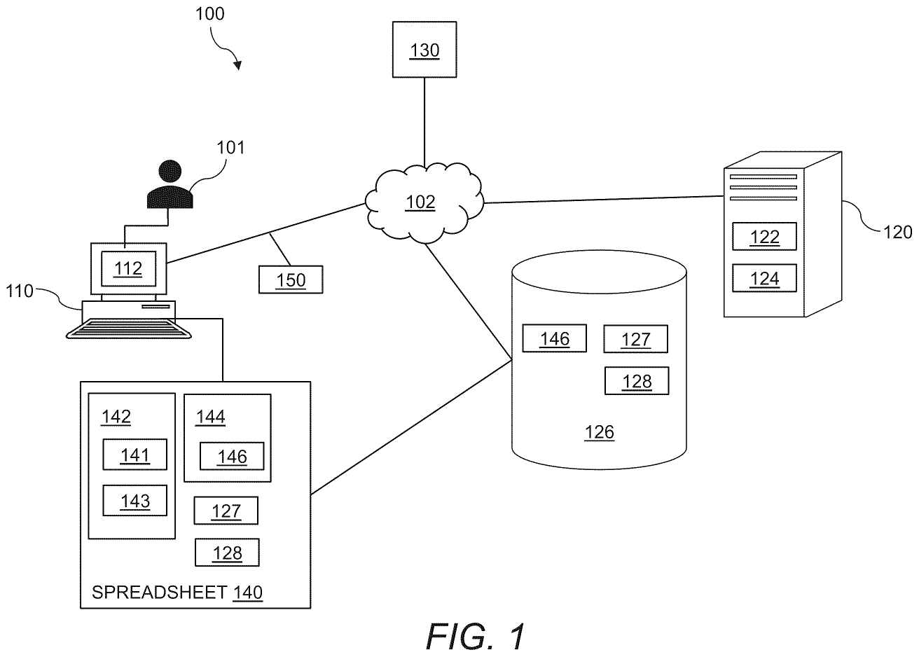

FIG. 1 illustrates a system 100 for managing memory utilization in processing spreadsheet functionality, in accordance with a representative example. In general, the system 100 may include a networked environment where a data network 102 interconnects a plurality of participating devices and/or users in a communicating relationship. The participating devices may, for example, include any number of user devices 110, remote computing resources 120, and other resources 130.

The data network 102 may be any network(s) or internetwork(s) suitable for communicating data and information among participants in the system 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m)), fifth generation (e.g., 5G), and/or other technologies, as well as any of a variety of corporate area or local area networks and other switches, routers, hubs, gateways, and the like that might be used to carry data among participants in the system 100.

Each of the participants of the data network 102 may include a suitable network interface comprising, e.g., a network interface card, which term is used broadly herein to include any hardware (along with software, firmware, or the like to control operation of same) suitable for establishing and maintaining wired and/or wireless communications. The network interface card may include without limitation a wired Ethernet network interface card (“NIC”), a wireless 802.11 networking card, a wireless 802.11 USB device, or other hardware for wired or wireless local area networking. The network interface may also or instead include cellular network hardware, wide area wireless network hardware or any other hardware for centralized, ad hoc, peer-to-peer, or other radio communications that might be used to connect to a network and carry data. In another aspect, the network interface may include a serial or USB port to directly connect to a local computing device such as a desktop computer that, in turn, provides more general network connectivity to the data network 102.

The user devices 110 may include any devices within the system 100 operated by one or more users 101 for practicing the techniques as contemplated herein. Specifically, the user devices 110 may include any device for creating, preparing, editing, receiving, and/or transmitting (e.g., over the data network 102) a spreadsheet 140 and information related thereto such as input cells 142, target cells 144, output data 146, one or more operations 127, and one or more mapping functions 128. Similarly, the user devices 110 may include any device for creating, preparing, editing, receiving, and/or transmitting (e.g., over the data network 102) other data or files in the system 100, such as a directive or a request 150 as described herein. The user devices 110 may also or instead include any device for managing, monitoring, or otherwise interacting with tools, platforms, and devices included in the systems and techniques contemplated herein. The user devices 110 may be coupled to the data network 102, e.g., for interaction with one or more other participants in the system 100.

By way of example, the user devices 110 may include one or more desktop computers, laptop computers, network computers, tablets, mobile devices, portable digital assistants, messaging devices, cellular phones, smart phones, portable media or entertainment devices, or any other computing devices that can participate in the system 100 as contemplated herein. As discussed above, the user devices 110 may include any form of mobile device, such as any wireless, battery-powered device, that might be used to interact with the networked system 100. It will also be appreciated that one of the user devices 110 may coordinate related functions (e.g., calling the mapping function 128, receiving or transmitting a request 150, and so on) as they are performed by another entity such as one of the remote computing resources 120 or other resources 130.

Each user device 110 may generally provide a user interface (e.g., included on a display 112 thereof), such as any of the user interfaces described herein. The user interface may be maintained by a locally executing application on one of the user devices 110 that receives data from, e.g., the remote computing resources 120 or other resources 130. In other embodiments, the user interface may be remotely served and presented on one of the user devices 110, such as where a remote computing resource 120 or other resource 130 includes a web server that provides information through one or more web pages or the like that can be displayed within a web browser or similar client executing on one of the user devices 110. The user interface may in general create a suitable visual presentation for user interaction on a display device of one of the user devices 110, and provide for receiving any suitable form of user input including, e.g., input from a keyboard, mouse, touchpad, touch screen, hand gesture, or other use input device(s).

The remote computing resources 120 may include, or otherwise be in communication with, a processor 122 and a memory 124, where the memory 124 stores code executable by the processor 122 to perform various techniques of the present teachings. More specifically, a remote computing resource 120 may be coupled to the data network 102 and accessible to the user device 110 through the data network 102, where the remote computing resource 120 includes a processor 122 and a memory 124, where the memory 124 stores code executable by the processor 122 to perform the steps of a method according to the present teachings.

The remote computing resources 120 may also or instead include data storage, a network interface, and/or other processing circuitry. In the following description, where the functions or configuration of a remote computing resource 120 are described, this is intended to include corresponding functions or configuration (e.g., by programming) of a processor 122 of the remote computing resource 120, or in communication with the remote computing resource 120, e.g., over the data network 102 or otherwise. In general, the remote computing resources 120 (or processors 122 thereof or in communication therewith) may perform a variety of processing tasks related to managing memory utilization in processing spreadsheet functionality as discussed herein. For example, the remote computing resources 120 may manage information received from one or more of the user devices 110, and provide related supporting functions such as determining or storing the mapping function 128, generating, receiving, and/or transmitting a request 150, communicating with other resources 130, storing data, and the like. The remote computing resources 120 may also or instead include backend algorithms that react to actions performed by a user 101 at one or more of the user devices 110. The backend algorithms may also or instead be located elsewhere in the system 100.

The remote computing resources 120 may also or instead include a web server or similar front end that facilitates web-based access by the user devices 110 to the capabilities of the remote computing resource 120 or other components of the system 100. A remote computing resource 120 may also or instead communicate with other resources 130 in order to obtain information for providing to a user 101 through a user interface on the user device 110. Where the user 101 specifies certain criteria for data processing, this information may be used by a remote computing resource 120 (and any associated algorithms) to access other resources 130. Additional processing may be usefully performed in this context such as recommending certain data processing operations and techniques.

A remote computing resource 120 may also or instead maintain, or otherwise be in communication with, a database 126 of content such as one or more operations 127, along with an interface for users 101 at the user devices 110 to utilize the content of such a database 126. Thus, in one aspect, a remote computing resource 120 may include a database 126 of operations 127, and the remote computing resource 120 may act as a server that provides a platform for selecting and using an operation 127, and/or providing supporting services related thereto.

A remote computing resource 120 may also or instead be configured to manage access to certain content (e.g., for an enterprise associated with a user 101 of the user device 110). In one aspect, a remote computing resource 120 may manage access to a component of the system 100 by a user device 110 according to input from a user 101.

The other resources 130 may include any resources that may be usefully employed in the devices, systems, and methods as described herein. For example, the other resources 130 may include without limitation other data networks, human actors (e.g., programmers, researchers, annotators, editors, analysts, and so forth), sensors (e.g., audio or visual sensors), data mining tools, computational tools, data monitoring tools, and so forth. The other resources 130 may also or instead include any other software or hardware resources that may be usefully employed in the networked applications as contemplated herein. For example, the other resources 130 may include payment processing servers or platforms used to authorize payment for access, content or feature purchases (e.g., certain files, operations 127, or mapping functions 128), or otherwise. In another aspect, the other resources 130 may include certificate servers or other security resources for third-party verification of identity, encryption or decryption of data, and so forth. In another aspect, the other resources 130 may include a desktop computer or the like co-located (e.g., on the same local area network with, or directly coupled to through a serial or USB cable) with one of the user devices 110 or remote computing resources 120. In this case, the other resource 130 may provide supplemental functions for the user device 110 and/or remote computing resource 120. Other resources 130 may also or instead include supplemental resources such as scanners, cameras, printers, input devices, and so forth.

The other resources 130 may also or instead include one or more web servers that provide web-based access to and from any of the other participants in the system 100. While depicted as a separate network entity, it will be readily appreciated that the other resources 130 (e.g., a web server) may also or instead be logically and/or physically associated with one of the other devices described herein, and may, for example, include or provide a user interface for web access to a remote computing resource 120 or a database 126 in a manner that permits user interaction through the data network 102, e.g., from a user device 110.

It will be understood that the participants in the system 100 may include any hardware or software to perform various functions as described herein. For example, one or more of the user device 110 and the other resources 130 may include a memory 124 and a processor 122.

The various components of the networked system 100 described above may be arranged and configured to support the techniques described herein in a variety of ways. For example, in one aspect, a user device 110 connects through the data network 102 to a server (e.g., that is part of one or more of the remote computing resource 120 or other resources 130) that performs a variety of processing tasks related to managing memory utilization in processing spreadsheet functionality. For example, the remote computing resource 120 may include a server that hosts a web application that runs a platform for processing spreadsheet functionality including memory management techniques described herein. More specifically, a user 101 associated with the user device 110 and having appropriate permissions for using the system 100 may use the user device 110 to transmit a spreadsheet 140 over the data network 102 to the remote computing resource 120, or to otherwise provide access to the spreadsheet 140 by the remote computing resource 120. The spreadsheet 140 may include input cells 142 each having input data 141 and a cell address 143. The spreadsheet 140 may also include, or be associated with, one or more operations 127 programmatically configured to manipulate the input data 141 to generate data in target cells 144 which may in some cases include output data 146.

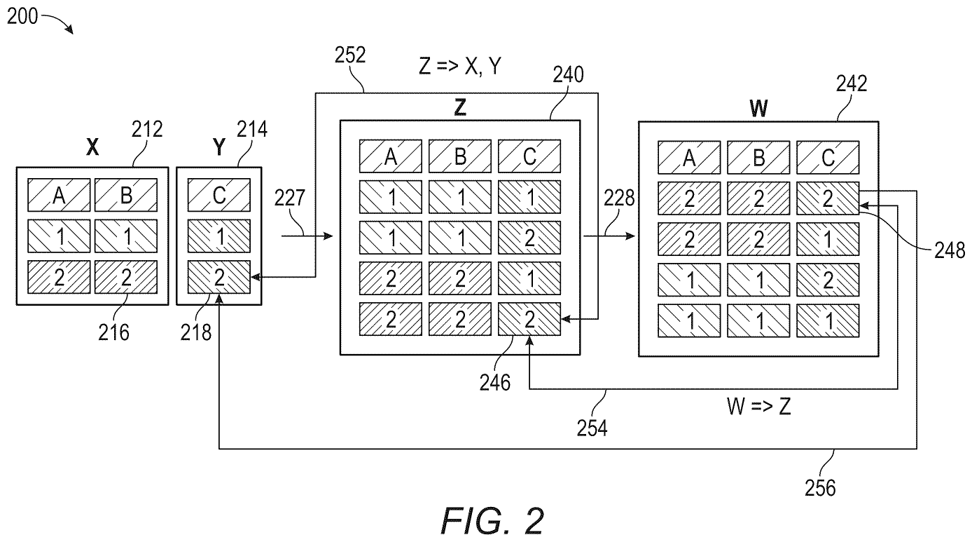

The operations 127 may be associated with or describe at least one of the input cells 142, the target cells 144, and the output data 146. One or more operations 127 may be included in the spreadsheet 140 (e.g., the operation 127 may be a function or directive embedded within the spreadsheet 140; for example, the collection of input cells 142 may contain one or more operations 127). The operations 127 may also or instead be stored in the database 126 and may be referenced, accessed, or retrieved by the system 100 for processing the spreadsheet 140. One or more mapping functions 128 may be determined (e.g., by a processor 122 of the remote computing resource 120) or selected (e.g., from a database 126 including mapping functions) to define how target cells 144 relate to input cells 142. Each mapping function 128 may be a single function or may instead include a series of functions, a group of nested functions, or the like (see, e.g., the example process 200 of FIG. 2). In some cases, the mapping function 128 may describe a one to one relationship between the collection of input cells 142 and the collection of target cells 144. In other cases, the mapping function 128 may be an inverse operation of one or more of the operations 127. For example, a mapping function 128 may include one or more operations such as filter, group, sort, cartesian product, join, graph traversal, merge, or the like, and may be composed in various ways such as a single operation, a series of operations, a group of nested operations, or the like.

The target cells 144 may represent either the result of an intermediate operation (or intermediate data, e.g., the output of a non-final step in a sequence of operations) or output data (e.g., the final output of a sequence of operations, or of an operation including multiple steps). In some aspects, the target cells 144 may be virtual, such as before a request for values of the target cells is received. The virtual nature of cells represents a fundamental aspect of the memory management approach described in the present teachings, where target cells may exist programmatically without their data being materialized in memory until explicitly requested. For example, virtual target cells may be displayed as blank, empty, hidden, grayed (representing inactive), or similar, providing a visual representation of the spreadsheet structure while the actual data remains unmaterialized. This virtualization approach may offer significant benefits including substantial memory savings by avoiding the storage of intermediate and output data that may never be accessed, improved computational performance by eliminating unnecessary calculations for unrequested cells, enhanced scalability for processing large datasets that would otherwise exceed available memory constraints, or more efficient handling of complex operations where only a subset of results may be needed. The virtual cell architecture may also enable dynamic computation where values are calculated on-demand rather than pre-computed, allowing for real-time updates when input data changes without requiring recalculation of all dependent cells. Additionally, virtual cells may facilitate better resource allocation in distributed computing environments, as the system can prioritize computation resources for actively requested data while maintaining the logical structure and relationships of the entire spreadsheet without the associated memory overhead. In some aspects, the target cells 144 may be displayed to a user without the data thereof being rendered. After receiving a request for values of the target cells (e.g., from a user 101 or from the processor 122) the values of the target cells may be rendered and may also, in some cases, be displayed.

The processing of the spreadsheet 140 may occur anywhere in the system 100, such as locally at the user device 110, or remotely at the remote computing resource 120 or a web platform hosted by same. For example, the remote computing resource 120 may transmit a mapping function 128 to the user device 110 over the data network 102, where a user 101 operating the user device 110 may then execute the mapping function 128. Also or instead, the remote computing resource 120 may execute the mapping function 128, and then the remote computing resource 120 may transmit output data 146 to the user device 110 over the data network 102.

In an aspect, many of the techniques of the present teachings are performed by the remote computing resource 120. For example, the remote computing resource 120 may include an analysis engine (or otherwise a processor 122) configured by computer-executable code to analyze and read the spreadsheet 140, e.g., to determine which operations 127 are in the spreadsheet, if duplicate data is present in the spreadsheet, and similar. Similarly, such an analysis engine of the remote computing resource 120 may determine mapping functions 128 related to the spreadsheet functionality, call the mapping functions when requests for data are received, and determine values of target cells based on the mapping functions.

FIG. 2 illustrates a spreadsheet process, in accordance with a representative example. The process 200 may be performed by the system 100 of FIG. 1, and may thus include any of the features described with reference thereto, and vice-versa. In general, the process 200 illustrates the relationships between one or more collections of input cells 212 and 214, a first collection of target cells 240, and a second collection of target cells 242.

The process 200 may involve receiving one or more collections of input cells, such as those in collections 212 and 214. Each cell of the input cells may have a cell address, which may include some or all of: the row location of the cell, the column location of the cell, and the name of the worksheet where the cell is located. For example, a cell address for input cell 216 may include (Row 2, Column B, Sheet X), or similar indicators of the address information. Multiple collections of input cells may, or may not, be provided in the same worksheet (for example, although the collection of input cells 212 is shown on worksheet X and the collection 214 is shown on worksheet Y, these may instead reside within the same worksheet). In general, the collection of input cells may include input data, e.g., the value “2” is the input data of cell 216.

A first operation 227 may be programmatically configured to manipulate input data within one or more of the collections of input cells 212 and 214 to generate intermediary data, such as that of the first collection of target cells 240 (worksheet Z). In this example, the first operation 227 is a Cartesian product of input cells 212 and 214. In some aspects, the Cartesian product operation (i.e., the first operation 227 in this example process 200) may be used to generate a new set of data by combining elements from two or more input collections. For example, consider the 2×2 array in collection 212 and the 1×2 array in collection 214. The Cartesian product of these arrays (i.e., output of the first operation 227) results in a 4×3 array in the first collection of target cells 240, where each row is a combination of one row from each input array. In general, the Cartesian product operation may create all possible combinations of elements from the input arrays, resulting in a significantly larger set of data in the target cells. The process 200 may use mapping functions to efficiently reference these new combinations back to the original input cells, reducing memory usage by avoiding the need to store redundant data. In the case of operations like the Cartesian product, where the output can be significantly larger than the input, the memory savings may be particularly pronounced. Instead of storing each element of the output array individually (the 4×3 array in this example), the system may merely store the original input arrays (2×2 and 1×2 arrays in the example), along with the mapping function that describes how to generate each element of the output array. When a specific cell value is requested, the system can compute it on-demand using the mapping function, potentially reducing the time and resources needed for initial calculations. The memory efficiency may extend to scenarios involving multiple operations or complex data transformations. Rather than materializing and storing the results of each intermediate step, the system can chain together multiple mapping functions, allowing it to derive final results directly from the initial input data when needed. This approach may be particularly valuable in scenarios involving large-scale data analysis, financial modeling, or scientific computations where memory constraints might otherwise limit the scale or complexity of operations that can be performed. This approach may also provide benefits in terms of computation speed and data integrity. Additionally, by maintaining references to the original input data, the system may more easily propagate changes or updates throughout the spreadsheet.

A first mapping function 252 may be determined to reference the first collection of target cells 240 to the collections of input cells 212 and 214. The first mapping function 252 may be based on the first operation 227, in this case the Cartesian product operation. In an example use case, the process 200 may include receiving a request for a value of a first target cell 246. The process 200 may call the first mapping function 252 to determine the location of the related input cell 218 (within collection 214). The process 200 may access the data of input cell 218, and determine the value of the first target cell 246 based on this data. In some cases, the value of the first target cell 246 may be displayed to a user.

A second operation 228 may be programmatically configured to manipulate data within the first collection of target cells 240 to generate output data, such as that of the second collection of target cells 242 (worksheet W). In this example, the second operation 228 is a sort function.

A second mapping function 254 may be determined to reference the second collection of target cells 242 to the first collection of target cells 240. The second mapping function 254 may be based on the second operation 228, specifically in this example, it may include the sort function. For example, the system may receive a request for a value of a second target cell 248. The system may call the second mapping function 254 to determine the location of the related input cell (in this case the input cell is cell 246 of the first collection of target cells 240). The system may then access the data of the input cell and may display the value, utilize the value in further operations, and the like.

In this example, the second collection of target cells 242 may be considered output data, e.g., if this data is the end result of the operations being performed, such as operations 227 and 228. The first collection of target cells 240 may be considered intermediate data, as it is the result of a non-final operation in a series of operations (the output of first operation 227 in the series of operations 227 and 228). In general, intermediate data may or may not be of interest to, or be directly provided to, a user. In some cases, intermediate data may also be considered input data, e.g., when it is the input to a subsequent operation (such as in the case of cell 246 discussed in this example).

In some cases, a mapping function (such as third mapping function 256) may include (i) a first mapping function (e.g., first mapping function 252) that references a first collection of target cells representing intermediary data to the collection of input cells, and (ii) a second mapping function (e.g., the second mapping function 254) that references a second collection of target cells representing output data to the first collection of target cells. Any of the first, second, or third mapping functions may be called independently of one another. For example, the first mapping function 252 may be called independently of the second mapping function 254 to determining a value of one or more cells of the first collection of target cells 240. The third mapping function 256 may include more than two independent mapping functions, and the aforementioned process may be applied, mutatis mutandis, to any number of mapping functions. In some cases, the third mapping function 256 may be used to determining a value of one or more cells of the second collection of target cells 242 without determining a value of the first collection of target cells 240. Said another way, when executing a chain of operations with related mapping functions, intermediate values need not be explicitly determined; instead, the reference of the related mapping function may be sufficient information to execute the operations (e.g., the reference may be used as an input to a subsequent mapping function).

The following are non-limiting examples of how a mapping function may be determined. For mapping a one-to-one relationship of input & output (e.g., for simple operations like cell copying or basic arithmetic), the mapping function may establish a direct correspondence between each input cell and its corresponding output cell. For example, if an operation adds a constant value of 10 to each cell in a range A1:A100 to produce output in range B1:B100, the mapping function may be defined as: ‘map(target_cell)=source_cell_address where target_cell.row=source_cell.row and target_cell.column=source_cell.column+1’. The mapping function may store the inverse relationship, allowing the system to determine that cell B5 maps back to cell A5, and the operation to apply is “add 10 to the value in A5.”

For mapping a series of operations (e.g., multiple operations chained together), the mapping function may reference intermediate steps or may collapse the entire chain into a single function. For instance, if data flows from input cells sequentially through a filter operation, a sort operation, and a sum operation, the mapping function may either: (i) store references to each intermediate step, e.g., ‘map(final_cell)→intermediate_cell_2→intermediate_cell_1→input_cell’ or (ii) collapse the steps into a direct mapping: ‘map(final_cell)={input_range, [filter_criteria, sort_order, sum_function]}’. The system may determine which approach to use based, e.g., on memory efficiency and computational complexity considerations.

For mapping a nested function, e.g., ‘SUM(FILTER(SORT(input_range, sort_column), filter_criteria))’, the mapping function may decompose the nested structure into its constituent parts. The mapping function may store each of: the outermost function (SUM), the parameters and intermediate functions (FILTER with its criteria), the innermost function (SORT with its parameters), and the original input range. When a request is made for the final result, the mapping function may execute these operations in the correct order, or may use mathematical properties to optimize the computation. For example, if only a subset of the final result is requested, the mapping function may determine which portions of the input data are actually needed and avoid processing unnecessary data. The mapping function may also, or instead, store metadata about data dependencies, allowing the system to efficiently handle updates to input data by only recalculating affected portions of the nested operation chain.

In some cases, a mapping function may relate to multiple operations without the operations having their own distinct mapping function (in such a case, it may not be possible to realize all intermediate data). In other cases, each operation within a spreadsheet process may relate to a distinct mapping function and may, or may not, also relate to higher level, multi-operational mapping functions.

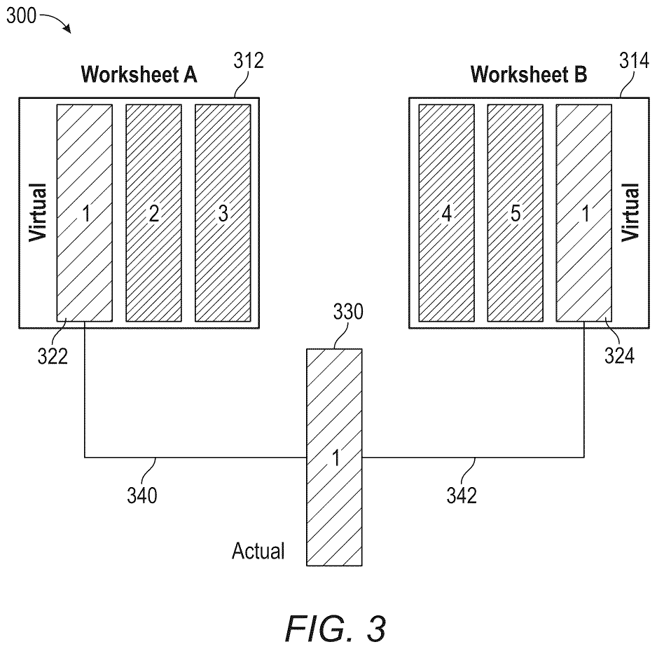

FIG. 3 illustrates a spreadsheet process, in accordance with a representative example. The process 300 may be performed by the system 100 of FIG. 1, and may thus include any of the features described with reference thereto, and vice-versa. In general, the process 300 illustrates a technique of managing memory usage in a scenario where duplicate data exists between one or more collections of input cells 312 and 314.

By way of example, duplicate data may be present in a financial spreadsheet when dealing with recurring transactions or repeated entries across different sections or worksheets. A financial spreadsheet may contain multiple instances of the same customer information, such as name, address, and contact details, across various worksheets tracking different types of transactions or financial periods. Similarly, product codes, employee IDs, or account numbers may be duplicated in different parts of the spreadsheet, such as in sales reports, inventory tracking, and financial summaries. In some cases, the duplicate data may be provided as input data. In other cases, a part of an operation (such as a directive) may provide instructions to duplicate certain data from one part of the spreadsheet to another.

The system may receive, or generate, one or more collections of cells, such as the first collection of cells 312 and the second collection of cells 314. Each cell within the collections may have a cell address. The system may identify that duplicate data is present between the collections of cells (for example, column 322 may include data that is a duplicate of data in column 324). The system may identify duplicate data based on, for example, an operation relating the column 322 to the column 324, on a scan and comparison of the data, or other techniques. The system may, for example, identify duplicate data by scanning collections of input cells for identical values or patterns, such as matching customer information across multiple worksheets. The system may also, or instead, detect duplicate data by analyzing cell addresses and comparing data entries in columns or rows that are referenced by similar operations, such as when a directive instructs duplication of product codes from one worksheet to another. In some cases, the system may utilize backend algorithms to compare data across different sections of a spreadsheet, flagging repeated entries such as employee IDs or account numbers. Additionally, or instead, the system may identify duplicate data by evaluating metadata or annotations associated with cells, recognizing when identical data is present in both input and target cell collections due to recurring transactions or automated data imports.

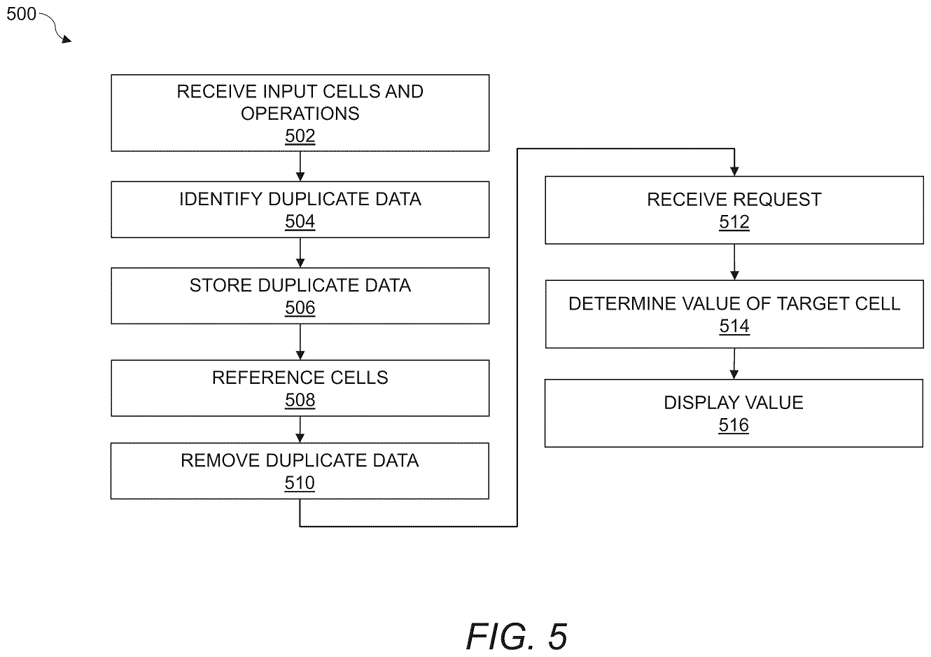

The duplicate data may be stored independently as an “actual” third collection of cells 330. This third collection of cells may be referenced by both original collections (e.g., in column 322 and column 324). One or more references 340, 342 may be provided that reference the third collection of cells 330 to one or both of the first and second collections of cells 312 and 314. Aspects of this process may be similar to steps described in the method 500 of FIG. 5.

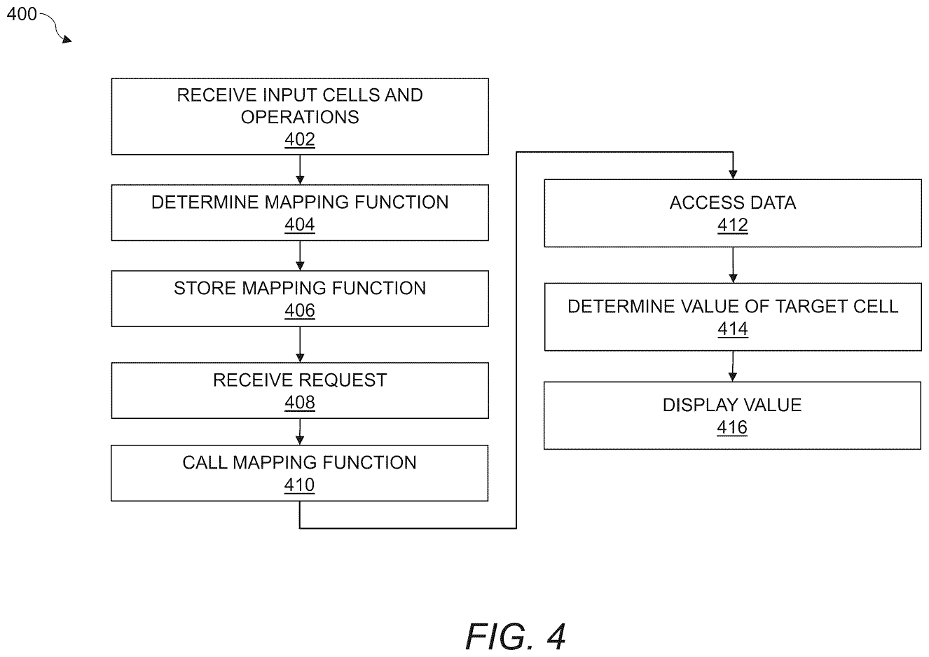

FIG. 4 is a flow chart of a method for managing memory utilization for spreadsheets, in accordance with a representative example. The method 400 may utilize any of the systems or platforms described herein, e.g., the system 100 described with reference to FIG. 1. In general, the method 400 represents a technique for determining a mapping function that references target cells to input cells, calling the mapping function when data from a target cell is requested, and accessing input data according to the mapping function to determine the data of the requested target cell. This approach may allow for efficient memory utilization by avoiding the need to store intermediate data and output data explicitly.

As shown in step 402, the method 400 may include receiving a collection of input cells and one or more operations. The collection of input cells may be received, for example, from a user 101 through a user device 110. In other cases, the collection of input cells may be the output of a previously executed operation. In general, the input cells include input data, and each of the input cells has a cell address. The one or more operations may be programmatically configured to manipulate the input data to generate output data. The operations may be received with the input data (e.g., as functions or directives within an input spreadsheet), may be selected through a user interface, or provided by other means described herein.

As shown in step 404, the method 400 may include determining a mapping function programmatically configured to reference a collection of target cells to the collection of input cells. The mapping function may be similar to the mapping function 128 of system 100, and may be based on the one or more operations. The collection of target cells may represent either output data or intermediary data used to generate the output data (e.g., as described in FIG. 2).

As shown in step 406, the method 400 may include storing the mapping function to a database. The database may be a component of the system, such as database 126, or may be an external database accessible by the system. Storing the mapping function to a database may provide advantages such as enabling efficient management and retrieval of mapping functions as needed. This approach may allow for persistent storage of a mapping function, enabling it to be accessed across multiple sessions or by different users of the system. The database storage may also facilitate version control of mapping functions, allowing the system to maintain a history of changes and revert to previous versions if necessary. In some cases, storing the mapping function in a database may enable the system to optimize performance by caching frequently used mapping functions. The system may analyze usage patterns and preload commonly accessed mapping functions, potentially reducing computation time and improving overall system responsiveness. The database storage of mapping functions may also support scalability of the system. As the complexity and number of spreadsheets grow, the ability to store and manage mapping functions in a centralized database may become increasingly important. This approach may allow the system to handle larger datasets and more complex operations efficiently. In some implementations, the system may store metadata associated with the mapping function alongside the function itself in the database. This metadata may include information such as the creation date, last modification date, author, and associated spreadsheets or operations. Such additional information may aid in managing and organizing mapping functions, especially in environments where multiple users or teams collaborate on spreadsheet projects.

As shown in step 408, the method 400 may include receiving a request for a first value of a target cell. For example, as shown in FIG. 1, the system 100 may receive the request 150 through a user device 110, where a user may input commands or select options that generate requests. In some aspects, the system may receive requests for various amounts of data from the collection of target cells. While at a minimum, a request may be for a single value of a target cell, the system may be capable of handling more complex requests. For example, a request may be for an entire column of data, an entire row, or a specified range of values within the collection of target cells. In some cases, the request may even encompass the entire collection of target cell values.

As shown in step 410, the method 400 may include calling the mapping function. The mapping function may be called after receiving the request, and may be used to determine the cell address of a first input cell to which the target cell (e.g., the target cell requested in step 408) refers. In an example of using a mapping function to determine a cell address of an input cell, the input cells may be in a range A1:A10 and contain values [1, 2, 3, 4, 5, 6, 7, 8, 9, 10], and an operation may sort these values in descending order to produce target cells in range B1:B10 with values [10, 9, 8, 7, 6, 5, 4, 3, 2, 1]. The system may determine a mapping function based on the sort operation, as described in step 404. The mapping function may store the transformation as:
sort_mapping={
B1→A10, // target cell B1 (value 10) maps to input cell A10
B2→A9, // target cell B2 (value 9) maps to input cell A9
. . .
B10→A1// target cell B10 (value 1) maps to input cell A1
}

When a request is received for the value of target cell B2 in step 408, the system may call the mapping function in step 410. The mapping function executes:
target_cell=“B2”
input_cell_address=sort_mapping.get(target_cell)
// Returns: “A9”,
where A9 is the cell address determined using the mapping function. This approach allows the system to avoid storing the entire sorted array in memory, instead maintaining only the original input data and the mapping function that describes the transformation relationship. The mapping function may be stored in a memory, such as memory 124, and may be executed by a processor, such as the processor 122, as shown in FIG. 1.

As shown in step 412, the method 400 may include accessing the input data of the first input cell using the cell address (e.g., the cell address determined by calling the mapping function in step 410). Accessing the input data may be executed by a processor, such as the processor 122 shown in FIG. 1.

As shown in step 414, the method 400 may include determining the value of the target cell. Determining the value may be based at least on the input data of the first input cell (e.g., the input data accessed in step 412). Determining the value may also be based, at least in part, on one or more operations associated with the target cell.

As shown in step 416, the method 400 may include displaying the value of the target cell (e.g., the value determined in step 414). For example, the value of the target cell may be displayed via a user interface, such as the display 112 of the user device 110 shown in FIG. 1.

FIG. 5 is a flow chart of a method for managing memory utilization for spreadsheets, in accordance with a representative example. The method 500 may utilize any of the systems or platforms described herein, e.g., the system 100 described with reference to FIG. 1. In general, the method 500 represents a technique for reducing memory usage for duplicate data. In some aspects the method 500 may include one or more of the steps described in the example of FIG. 3.

As shown in step 502, the method 500 may include receiving a first collection of cells and one or more operations. The operations may be programmatically configured to manipulate the first collection of cells to generate a second collection of cells. The first collection of cells and the one or more operations may have features in common with those described in step 402 of the method 400. The second collection of cells may be similar to the target cells 144 of the system 100 shown in FIG. 1.

As shown in step 504, the method 500 may include identifying the presence of duplicate data in common between the first collection of cells and the second collection of cells. The identification may be based, in whole or in part, on the one or more operations to be performed on the first collection of cells. Examples of spreadsheets were duplicate data may be present are discussed with reference to FIG. 3. An identifier of duplicate data may include one or more cell addresses, or ranges thereof.

As shown in step 506, the method 500 may include storing the duplicate data independently of the first collection of cells and the second collection of cells. The duplicate data may be stored, e.g., in a memory 124 or a database 126 of the system 100 shown in FIG. 1.

As shown in step 508, the method 500 may include referencing each of the first collection of cells and the second collection of cells to the duplicate data (e.g., the duplicate data stored in step 506). In some aspects, the reference to duplicate data may be similar to the mapping function; for example, the reference may include a one to one mapping of the duplicate data to the first collection of cells and/or the second collection of cells.

As shown in step 510, the method 500 may include removing the duplicate data from the first collection of cells. In this case, the cells from which the data is removed exist virtually, as the data is stored in the duplicate data and may be retrieved when needed by calling the reference of step 508. In some cases, duplicate data may also be removed from the second collection of cells. Alternatively, duplicate data destined for the second collection of cells (based on execution of one or more operations) may not be generated (and therefore does not need to be removed). Instead of generating such data, these cells may also be virtual and the duplicate data for these cells may be retrieved by calling the reference of step 508.

As shown in step 512, the method 500 may include receiving a request for a value of a target cell within one of the first collection of cells and the second collection of cells. For example, the system 100 may receive the request 150 through a user device 110. This step may be similar to the step 408 of the method 400.

As shown in step 514, the method 500 may include, after receiving the request, determining the first value of the target cell based on the reference to the duplicate data. This step may be similar to the step 414 of the method 400.

As shown in step 516, the method 500 may include displaying the value of the first collection of cells or the second collection of cells (e.g., the identified as duplicate in step 504). For example, the values of these cells may be displayed via a user interface, such as the display 112 of the user device 110 shown in FIG. 1.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from the same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer program product for managing memory utilization in processing spreadsheet functionality, the computer program product comprising computer executable code embodied in a non-transitory computer readable medium that, when executing on one or more computing devices, performs the steps of:
receiving (i) a collection of input cells including input data, each of the input cells having a cell address, and (ii) one or more operations programmatically configured to manipulate the input data to generate output data;
determining, based on the one or more operations, a mapping function programmatically configured to reference a collection of target cells to the collection of input cells, the collection of target cells representing one of the output data and intermediary data used to generate the output data, wherein the mapping function includes: (i) a first mapping function that references a first collection of target cells representing intermediary data to the collection of input cells, and (ii) a second mapping function that references a second collection of target cells representing output data to the first collection of target cells;
receiving a request for a first value of a target cell of the collection of target cells;
after receiving the request, calling the mapping function to determine the cell address of a first input cell to which the target cell refers;
accessing the input data of the first input cell using the cell address; and
determining the first value of the target cell based at least on the input data of the first input cell.

2. The computer program product of claim 1, wherein the one or more operations include at least one of a function and a directive associated with the collection of input cells.

3. The computer program product of claim 1, wherein the one or more operations specify at least one of generation, manipulation, and arrangement of at least one of the input cells and the target cells.

4. The computer program product of claim 1, wherein the one or more operations include a directive, the directive including information related to at least one of duplicating a cell, filtering a cell, sorting a cell, and reordering a cell.

5. The computer program product of claim 1, wherein the one or more operations include one or more of a mathematical function and a computing function.

6. The computer program product of claim 1, wherein each of the one or more operations relates to a distinct mapping function.

7. The computer program product of claim 1, wherein the collection of input cells contains the one or more operations.

8. The computer program product of claim 1, further comprising code that, when executing on one or more computing devices, performs the steps of: calling the first mapping function independently of the second mapping function, and determining a value of one or more cells of the first collection of target cells.

9. The computer program product of claim 1, further comprising code that, when executing on one or more computing devices, performs the step of determining a value of one or more cells of the second collection of target cells without determining a value of the first collection of target cells.

10. The computer program product of claim 1, wherein the mapping function includes an inverse of the one or more operations.

11. The computer program product of claim 1, wherein the mapping function describes a one to one relationship between the collection of input cells and the collection of target cells.

12. The computer program product of claim 1, further comprising code that, when executing on one or more computing devices, performs the step of storing the mapping function to a database.

13. The computer program product of claim 1, further comprising code that, when executing on one or more computing devices, performs the step of, after determining the first value of the target cell, displaying the target cell via a user interface.

14. The computer program product of claim 13, wherein, before receiving the request for the first value of the target cell, the target cell is displayed as one or more of the following: blank, empty, zero value, hidden, or marked as inactive.

15. The computer program product of claim 1, wherein, before receiving the request for the first value of the target cell, the target cell being virtual.

16. A computer program product for managing memory utilization in processing spreadsheet functionality, the computer program product comprising computer executable code embodied in a non-transitory computer readable medium that, when executing on one or more computing devices, performs the steps of:
receiving (i) a collection of input cells including input data, each of the input cells having a cell address, and (ii) one or more operations programmatically configured to manipulate the input data to generate output data;
determining, based on the one or more operations, a mapping function programmatically configured to reference a collection of target cells to the collection of input cells, the collection of target cells representing one of the output data and intermediary data used to generate the output data;
receiving a request for a first value of a target cell of the collection of target cells, wherein, before receiving the request for the first value of the target cell, the target cell is displayed as one or more of the following: blank, empty, zero value, hidden, or marked as inactive;
after receiving the request, calling the mapping function to determine the cell address of a first input cell to which the target cell refers;
accessing the input data of the first input cell using the cell address; [and] determining the first value of the target cell based at least on the input data of the first input cell; and
after determining the first value of the target cell, displaying the target cell via a user interface.

17. The computer program product of claim 16, wherein the mapping function includes an inverse of the one or more operations.

18. The computer program product of claim 16, wherein the mapping function describes a one-to-one relationship between the collection of input cells and the collection of target cells.

19. The computer program product of claim 16, further comprising code that, when executing on one or more computing devices, performs the step of storing the mapping function to a database.

20. The computer program product of claim 16, wherein the one or more operations include a directive, the directive including information related to at least one of duplicating a cell, filtering a cell, sorting a cell, and reordering a cell.
